(19) United States
(12) Patent Application Publication
(10) Pub. No.: US 2011/0299132 A1
(43) Pub. Date: Dec. 8, 2011

(54) DOCUMENT SCANNING APPARATUS FOR AUTOMATICALLY TRANSFERRING IMAGE-PROCESSING PROGRAM

(76) Inventor: Yen-Cheng CHEN, Hsin Chu City (TW)

(21) Appl. No.: 13/105,537

(22) Filed: May 11, 2011

(30) Foreign Application Priority Data
Jun. 2, 2010 (TW) 099117682

(51) Int. Cl. H04N 1/40

(52) U.S. Cl. 358/448

(57) ABSTRACT

A document scanning apparatus for automatically transferring an image-processing program includes an image-capturing assembly, a memory unit, an I/O connection interface and a controlling module. The image-capturing assembly captures an image of an original and generates image data correspondingly. The memory unit stores the image-processing program. The I/O connection interface is provided for outputting and inputting data to and from an external device. The controlling module transfers the image-processing program from the memory unit to the I/O interface device, and the I/O connection interface outputs the image-processing program to a removable storage device connected thereto.

### CROSS REFERENCE TO RELATED APPLICATIONS

This application claims the benefit of the foreign application priority of Taiwan Application No. 099117682, which was filed on Jun. 2, 2010 and is incorporated herein by reference.

### BACKGROUND OF THE INVENTION

1. Field of the Invention

The present invention relates to a document scanning apparatus, and especially relates to a document scanning apparatus for automatically transferring an image-processing program to a removable storage device.

2. Description of the Prior Art

In the conventional art, the scanner transfers the document image to a connected host apparatus after finishing scanning the document, and then the host apparatus processes and displays the document image. Generally, a scanner driver is installed, in advance, on the host apparatus connected to the scanner for driving the scanner and receiving document images from the scanner. There is also another type of scanner which saves the scan images as a compressed file in the pdf or jpeg format, and outputs the compressed file to a memory card or a USB flash drive. When the users insert the memory card into the appropriate card slot on a computer, or connect the USB flash drive to a connection port of a computer, the users can view the images on the computer.

The disadvantage of the first type of scanner lies with its requirement of an exclusive driver. A different type of scanner driver is provided for each manufacturer and each model. Accordingly, if the users wish to use scanners of different models, the users need to install many different scanner drivers in the host apparatus in advance. And, it may not be possible for the users to install the scanner drivers in advance if the following events occur, and therefore the users are not able to use the scanners.

(1) Incomplete package—the scanner itself may come into user's possession without the full package and scanner driver, when the scanner is borrowed from someone else or shared among many people.

(2) No connection to the network/internet—the users are not able to download the scanner driver from the internet.

For the second type of scanner, it performs deskew, compression and crop processes on the scan images before saving them as files in the removable storage devices. Thus, the hardware section, such as an ASIC, for actually performing image processing, is enlarged or upgraded and it is difficult to reduce the cost while maintaining the required processing functions.

### SUMMARY OF THE INVENTION

Accordingly, an object of the present invention is to provide a document scanning apparatus for automatically transferring an image-processing program, which reduces the scanner production costs and gives users greater accessibility and availability of the document images.

To achieve the afore-described object, the document scanning apparatus of the present invention includes an image-capturing assembly, a memory unit, an I/O connection interface and a controlling module. The image-capturing assembly captures an image of an original and generates image data correspondingly. The memory unit stores an image-processing program. The I/O connection interface outputs and inputs data. The controlling module transfers the image-processing program from the memory unit to the I/O connection interface, and the I/O connection interface outputs the image-processing program to a removable storage device connected thereto.

The document scanning apparatus of the present invention transfers the image-processing program to the removable storage device. The image-processing program is automatically installed on a computer and then performs deskew, compression and crop processes on the scan images stored on the removable storage device, after the removable storage device is connected to the connection port or the memory card slot of the computer. In this way, users can view the scan images on the computer even without installing, in advance, the scanner driver on the computer; and it is not necessary for scanners to include electric circuits or chips for performing these image processing functions.

These and other objects, features and advantages of the present invention will become apparent upon consideration of the following detailed description of the preferred embodiment that is illustrated in the various figures and drawings.

### BRIEF DESCRIPTION OF THE DRAWINGS

FIG. 1 is a pictorial view of a document scanning apparatus according to a preferred embodiment of the present invention.

FIG. 2 is a side view of the document scanning apparatus in FIG. 1.

FIG. 3 is a block diagram of the document scanning apparatus according to the preferred embodiment of the present invention.

FIGS. 4A and 4B are implementations of the image-processing program according to the present invention.

### DETAILED DESCRIPTION

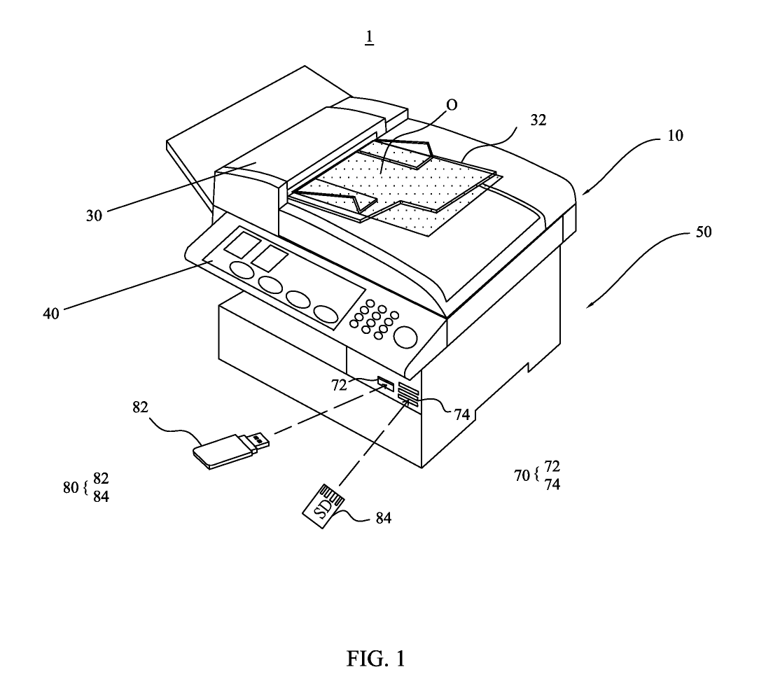

FIG. 1 is a pictorial view of a document scanning apparatus according to a preferred embodiment of the present invention. As shown in FIG. 1, the document scanning apparatus 1 in this embodiment is a multifunction device including a scanning section 10 and a printing section 50 and performing functions of scanning, printing, copy, email, fax and network filing. The document scanning apparatus 1 is equipped with an automatic document feeder (ADF) 30 for automatically feeding and transporting documents. Alternatively, the document scanning apparatus 1 may be a single-function scanner.

The document scanning apparatus 1 has a I/O connection interface 70, for example, a Universal Serial Bus (USB) connection port 72, a memory card interface (for SD, MS, CF, MMC formatted memory cards) 74, a parallel port, and etc., to connect to a removable storage device 80. The document scanning apparatus 1 saves image data to the removable storage devices 80, such as the USB flash drive 82, removable hard drive and memory card 84.

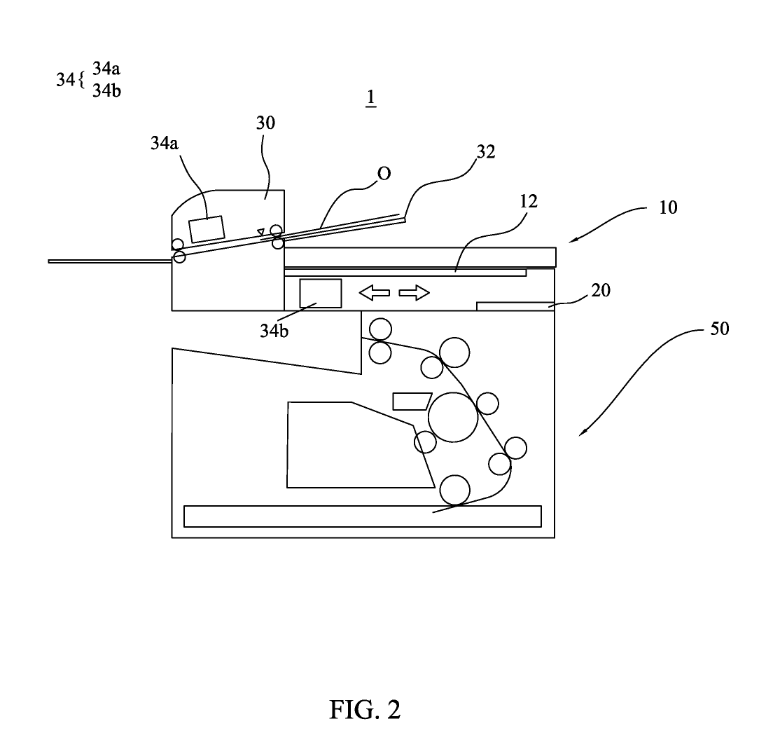

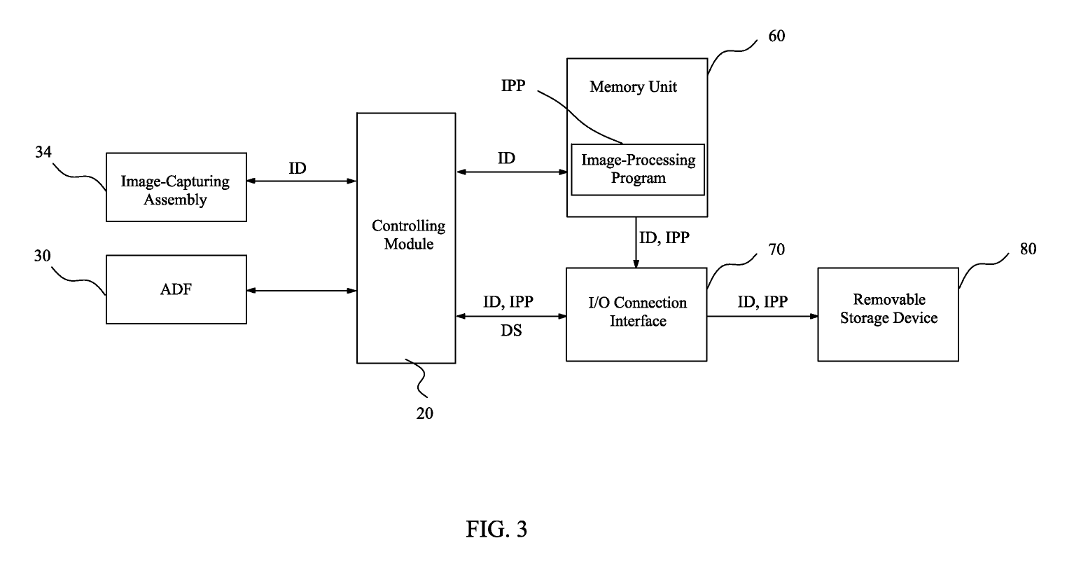

FIG. 2 is a side view of the document scanning apparatus in FIG. 1. As shown in FIG. 2, the document scanning apparatus 1 further include a controlling module 20, an image-capturing assembly 34 and memory unit 60 (as in FIG. 3). The memory unit 60 stores an image-processing program IPP. The image-capturing assembly 34 captures an image of an original O and generates image data ID correspondingly. The controlling module 20 transfers data and signals and controls the operation of the document scanning apparatus 1. The memory unit 60 comprises a non-volatile memory (NVM) and a random access memory (RAM), and is also used to store the image data ID, beside the image-processing program IPP. The image-capturing assembly 34 may be furnished with a charge-coupled device (CCD) image sensor or a contact type image sensor (CIS) for capturing the images. In this embodiment, the image-capturing assembly 34 contains two image sensing sets 34a and 34b, which are disposed in the ADF 30 and under a platen 12.

As shown in FIGS. 1 and 2, during the performance of the copy, scanning, email, fax or network filing function, users place the documents on the supply tray 32 of the ADF 30, or on the platen 12, and then input setting values and commands. Once the document scanning apparatus 1 receives any initiate request, the document scanning apparatus 1 starts to scan the document and outputs the image data ID to a destination when completing the process. For example, the document scanning apparatus 1 may save the image data ID to a local hard drive or to the removable storage device 80, or outputs the image data ID to the printing section 50 for printing, to an external device, such as a network terminal (for example, a PC or PDA) and a file server.

FIG. 3 is a block diagram of the document scanning apparatus according to the preferred embodiment of the present invention. Here the document scanning apparatus 1 of the present invention is operated in the automatic feeding mode. The ADF 30 feeds in and transports the original O, and in the mean time the image sensing set 34a captures the image of the original O and generates the corresponding image data ID. If the users select the USB flash drive 82 as the saving destination, the controlling module 20 accesses the image data ID stored in the memory unit 60 and transfers the image data ID to the I/O connection port 70, i.e., the USB connection port 72 in this embodiment. The USB connection port 72 then outputs the image data ID to the USB flash drive 82. The document scanning apparatus 1 may alternatively execute a data Direct Memory Access (DMA) operation to transfer the image data ID from the memory unit 60 directly to the I/O connection interface 70.

Under the circumstances, the controlling module 20 transfers the image-processing program IPP from the memory unit 60 to the I/O connection interface 70 as well, and the I/O connection interface 70 outputs the image-processing program IPP to the USB flash drive 82 connected thereto. For illustration, at the time when the controlling module 20 saves the image data ID to the USB flash drive 82 via the I/O connection interface 70, the controlling module 20 also transfers the image-processing program IPP together with the image data ID to the USB flash drive 82.

Alternatively, the controlling module 20 may save the image-processing program IPP to the removable storage device 80 when it is detected that the removable storage device 80 is connected to the I/O connection interface 70. In detail, when the USB connection port 72 detects the USB flash drive 82 connected, the USB connection port 72 transmits a detection signal DS to the controlling module 20. The controlling module 20 when receiving the detection signal DS accesses the image-processing program IPP in the memory unit 60 and outputs the image-processing program IPP to the USB flash drive 82 via the USB connection port.

In other words, the document scanning apparatus 1 is capable of outputting the image-processing program IPP to the removable storage device 80 after the completion of the scan operation or before the initiation of the scan operation. Or the document scanning apparatus 1 may output the image-processing program IPP to the removable storage device 80 during the scan operation if the document scanning apparatus 1 is furnished with a multi-tasking processor or multiple processors. For example, if the document scanning apparatus 1 is a single-function scanner, the document scanning apparatus 1 transfers the image-processing program IPP at any time to the removable storage device 80, so long as the connection is detected, without user selection of the saving destination.

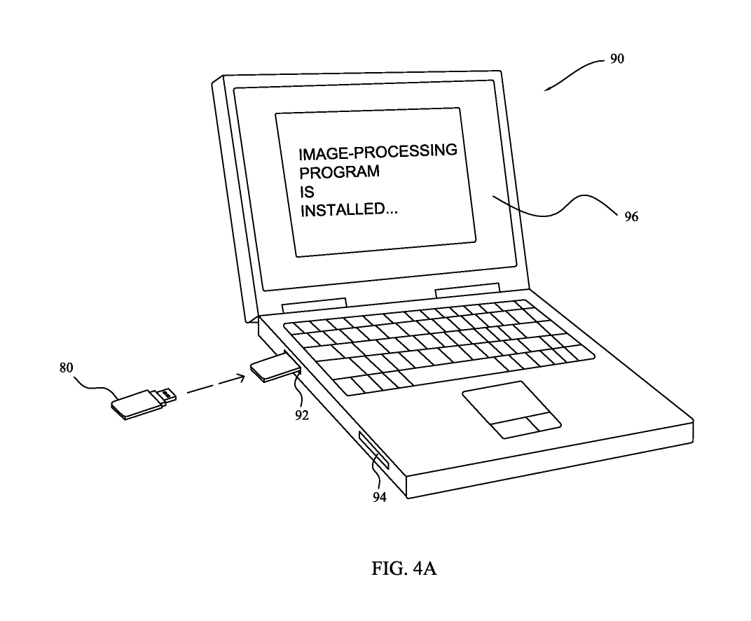

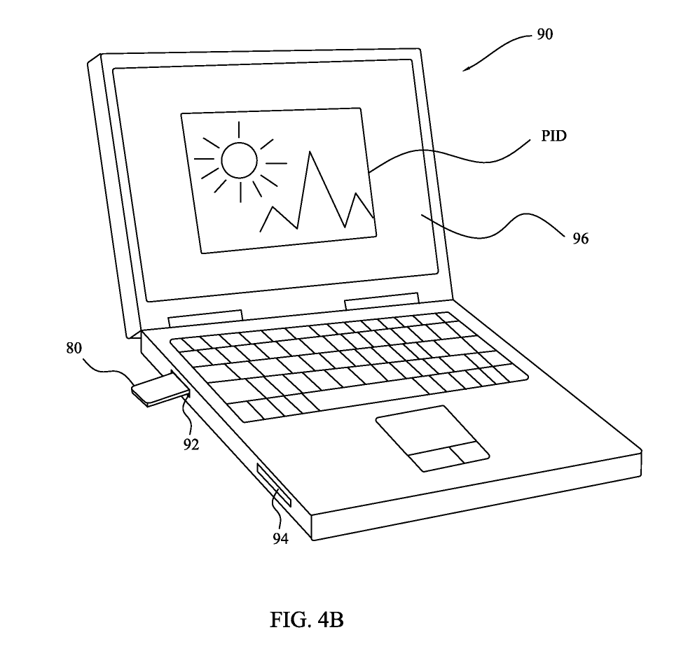

FIGS. 4A and 4B are implementations of the image-processing program according to the present invention. As shown in FIG. 4A, when the USB flash drive 82 storing the image-processing program IPP is plugged into a USB port 92 of a computer 90, and connected to the computer 90, the image-processing program IPP is automatically installed on the computer 90, because it has an auto-install function. In addition, the image-processing program IPP may also have an auto-execute function. Once the image-processing program IPP is installed, the computer 90 automatically executes the image-processing program IPP to perform the deskew, compression and crop processes on the image data ID storing in the USB flash drive 82, and displays the processed image PID, as shown in FIG. 4B, requiring no request from the users. Although aspects of the present invention are described and illustrated in the context of use of a USB flash drive, it should be recognized principles of the present invention can be achieved also by other portable and removable storage devices, such as the memory cards and electronic devices with capability of data storage.

According to the present invention, even without installation of scanner drivers on the computer terminals, the users are able to view the scan images on the computer terminals. Moreover, in the document scanning apparatus of the present invention, high speed chips and broad bandwidth transmission channels are not required, relatively reducing the production costs and product prices. Particularly in the situation that a compact scanner is used, the stand-alone scan operation by the document scanning apparatus of the present invention improves convenience for the users.

While the present invention has been described with respect to a limited number of embodiments, it is to be understood that the present invention is not limited to the disclosed exemplary embodiments. It is intended that the appended claims cover all modifications, equivalent structures and variations as fall within the true spirit and scope of this present invention. The specification and drawings are, accordingly, to be regarded in an illustrative rather than a restrictive sense.

What is claimed is:

1. A document scanning apparatus for automatically transferring an image-processing program, comprising:
an image-capturing assembly for capturing an image of an original and generating image data correspondingly;
a memory unit for storing the image-processing program;
an I/O connection interface for outputting and inputting data; and
a controlling module for transferring the image-processing program from the memory unit to the I/O connection interface, and the I/O connection interface outputs the image-processing program to a removable storage device connected thereto.

2. The document scanning apparatus of claim 1, wherein the controlling module further transfers the image data to the removable storage device via the I/O connection interface.

3. The document scanning apparatus of claim 1, wherein the controlling module transfers the image-processing program to the removable storage device upon detection of the removable storage device connected to the I/O connection interface.

4. The document scanning apparatus of claim 1, wherein the image-processing program is to be executed by a computer for performing an image deskew process.

5. The document scanning apparatus of claim 1, wherein the image-processing program is to be executed by a computer for performing an image compression process.

6. The document scanning apparatus of claim 1, wherein the image-processing program is to be executed by a computer for performing an image crop process.

7. The document scanning apparatus of claim 1, wherein the image-processing program has an auto-install function.

8. The document scanning apparatus of claim 7, wherein the image-processing program has an auto-execute function.
